(19) United States
(12) Patent Application Publication
(10) Pub. No.: US 2011/0086932 A1
(43) Pub. Date: Apr. 14, 2011

(54) POLYURETHANES DERIVED FROM LESQUERELLA OIL

(75) Inventor: Ronald M. Herrington, Brazoria, TX (US)

(73) Assignee: BORAL MATERIAL TECHNOLOGIES INC., San Antonio, TX (US)

(21) Appl. No.: 12/855,372

(22) Filed: Aug. 12, 2010

Related U.S. Application Data
(60) Provisional application No. 61/233,989, filed on Aug. 14, 2009.

(51) Int. Cl. C08L 75/04; C08J 9/35

(52) U.S. Cl. 521/170; 524/65

(57) ABSTRACT

Composite materials and methods for their preparation are described herein. The composite materials include a polyurethane made from the reaction of at least one isocyanate and at least one polyol, and coal ash (e.g., fly ash). The isocyanates for these composite materials may be selected from the group consisting of diisocyanates, polyisocyanates, and mixtures thereof. The at least one polyol includes lesquerella oil. The coal ash is present in amounts from about 40% to about 90% by weight of the composite material. Also described is a method of preparing a composite material, including mixing at least one isocyanate, at least one polyol, coal ash (e.g., fly ash), and a catalyst.

### CROSS-REFERENCE TO RELATED APPLICATIONS

This application claims priority to U.S. Provisional Application No. 61/233,989, filed Aug. 14, 2009, which is incorporated herein by reference in its entirety.

### BACKGROUND

Polymeric composite materials that contain organic or inorganic filler materials have become desirable for a variety of uses because of their excellent mechanical properties and weathering stability. Foamed versions of these materials can be relatively low density yet the filler materials can provide a composite material that is extremely strong. The polymer provided in the composite material can help provide good toughness (i.e., resistance to brittle fracture) and resistance to degradation from weathering to the composite when it is exposed to the environment. Thus, polymeric composite materials including organic or inorganic fillers can be used in a variety of applications.

### SUMMARY

Composite materials and methods for their preparation are described. The composite materials include a polyurethane formed by the reaction of at least one isocyanate and at least one polyol, and coal ash. The coal ash can be, for example, fly ash. The isocyanates used in these composites are selected from the group consisting of diisocyanates, polyisocyanates, and mixtures thereof. The polyols used in these composites include lesquerella oil. The fly ash may be present in amounts from about 40% to about 90% by weight of the composite material.

Also described is a method of preparing a composite material, which includes mixing at least one isocyanate selected from the group consisting of diisocyanates, polyisocyanates, and mixtures thereof; at least one polyol wherein the at least one polyol includes lesquerella oil, coal ash, and a catalyst. The coal ash can be, for example, fly ash. The at least one isocyanate and the at least one polyol react in the presence of the catalyst and coal ash to form the composite material. The amount of fly ash added in the mixing step is from about 40% to about 90% by weight of the composite material.

### DETAILED DESCRIPTION

Composite materials and methods for their preparation are described herein. The composite materials include a polyurethane formed by the reaction of at least one isocyanate selected from the group consisting of diisocyanates, polyisocyanates, and mixtures thereof; at least one polyol including lesquerella oil (i.e., the at least one polyol is lesquerella oil or a mixture of lesquerella oil and one or more other polyols); and coal ash (e.g., fly ash) present in amounts from about 40% to about 90% by weight of the composite material.

The composite materials described herein as well as their polyurethane component can be formulated with a high total environmental content. As used herein, the term total environmental content refers to the sum of the total renewable content and the total recyclable content used to form a composite material or its polyurethane component and is expressed as a weight percent. As used herein, renewable content refers to matter that is provided by natural processes or sources. Examples of renewable content include alcohol and oils from plants, such as lesquerella oil, castor oil, and soybean oil. Isocyanates derived from natural oil, such as castor oil pre-polymers and soybean oil pre-polymers, are also examples of renewable content. As used herein, recyclable content includes content that is derived from materials that would otherwise have been discarded. Examples of recyclable content include a recyclable polyol (e.g., one derived from recyclable polyester), glycerin sourced from a biodiesel plant, and a coal ash. Renewable content and recyclable content are used in the composites described herein to produce composite materials and polyurethane components with a high total environmental content.

The total environmental content of the polyurethane component (based only on the polyols and isocyanates) of the composite materials described herein can be greater than 35%. Further, the total environmental content of the polyurethane components described herein can be greater than 40% or greater than 45%. Examples of the total environmental content of the polyurethane components include environmental content greater than 36%, greater than 37%, greater than 38%, greater than 39%, greater than 41%, greater than 42%, greater than 43%, and greater than 44%. Additionally, the total environmental content of the polyurethane components can be about 36%, about 37%, about 38%, about 39%, about 40%, about 41%, about 42%, about 43%, about 44%, about 45%, about 46%, about 47%, about 48%, about 49%, or about 50%. As used herein, the term about is intended to capture the range of experimental error (e.g., ±1%) associated with making the specified measurement. Unless otherwise noted, all percentages and parts are by weight.

The total environmental content of the composite materials described herein can be greater than 75%. Further, the total environmental content of the composite materials described herein can be greater than 80% or greater than 85%. Examples of the total environmental content of the composite materials include total environmental content greater than 76%, greater than 77%, greater than 78%, greater than 79%, greater than 81%, greater than 82%, greater than 83%, and greater than 84%. Additionally, the total environmental content of the composite materials can be about 75%, about 76%, about 77%, about 78%, about 79%, about 80%, about 81%, about 82%, about 83%, about 84%, about 85%, about 86%, about 87%, about 88%, about 89%, or about 90%.

Polyurethanes useful with the composite materials described herein include those formed by the reaction of at least one monomeric, oligomeric poly- or di-isocyanates, or mixtures of these (sometimes referred to as isocyanates) and at least one polyol, wherein the at least one polyol includes lesquerella oil. Lesquerella oil (also referred to as bladder-pod oil) is a plant-based polyol containing hydroxy fatty acid content. Lesquerella oil is commercially available, e.g., from Nanjing Chemlin Chemical Co., Ltd in China. The at least one polyol can further include one or more polyester or polyether polyols.

The at least one polyol for use with the composite materials described herein can consist essentially of plant-based polyols. Examples of suitable polyols include plant-based polyester polyols and plant-based polyether polyols. The use of plant-based polyols also increases the renewable content of the composite material.

Suitable plant-based polyols include polyols containing ester groups that are derived from plant-based fats and oils. Accordingly, the plant-based polyols can contain structural elements of fatty acids and fatty alcohols. Starting materials for the plant-based polyols of the polyurethane component include fats and/or oils of plant-based origin with preferably unsaturated fatty acid residues. In addition to lesquerella oil, the plant-based polyols useful with the composite materials described herein include, for example, castor oil, coconut oil, corn oil, cottonseed oil, linseed oil, olive oil, palm oil, palm kernel oil, peanut oil, sunflower oil, tall oil, and mixtures thereof. In some embodiments, in addition to lesquerella oil, the plant-based polyols can include or be based on castor oil or soybean oil. Castor oil is a well-known, commercially available material, and is described, for example, in Encyclopedia of Chemical Technology, Volume 5, John Wiley & Sons (1979). Suitable castor oils include those sold by Vertellus Specialities, Inc., e.g., DB® Oil, and Eagle Specialty Products, e.g., T31® Oil.

In some embodiments, the at least one polyol can include a highly reactive polyol based on or in addition to lesquerella oil. The highly reactive polyol can include a large number of primary hydroxyl groups (e.g. 75% or more or 80% or more) as determined using fluorine NMR spectroscopy as described in ASTM D4273 [34]. Suitable highly reactive polyols can produce a Brookfield viscosity rise to a Brookfield viscosity of over 50,000 cP in less than 225 seconds, or less than 200 seconds when used in a standard Brookfield Viscosity Test procedure. In the standard Brookfield Viscosity Test procedure, the polyol is provided in an amount of 100 parts by weight and mixed with DC-197 surfactant (1.0 parts by weight), DABCO R-8020 catalyst (2.0 parts by weight), fly ash (460.0 parts by weight) and water (0.5 parts by weight) in a 600 mL glass jar at 1000 RPM for 30 seconds using any lab-duty electric stirrer equipped with a Jiffy Mixer brand, Model LM, mixing blade. MONDUR MR Light (a polymeric MDI, having a NCO weight of 31.5%, viscosity of 200 mPa·s @ 25° C., equivalent weight of 133, and a functionality of 2.8) is then added at an isocyanate index of 110 and the components mixed for an additional 30 seconds. The glass jar is then removed from the stirrer and placed on a Brookfield viscometer. The viscosity rise is measured using a for 20 minutes or until 50,000 cP is reached. The Brookfield Viscosity Test is described, for example, in Polyurethane Handbook Chemistry, Raw Materials, Processing Application, Properties, 2^{nd} Edition, Ed: Gunter Oertel; Hanser/Gardner Publications, Inc., Cincinnati, Ohio; Rigid Plastic Foams, T. H. Ferrigno (1963); and Reaction Polymers: Polyurethanes, Epoxies, Unsaturated Polyesters, Phenolics, Special Monomers and Additives: Chemistry, Technology, Applications, Wilson F. Gum et al. (1992), which are all herein incorporated by reference. In some embodiments, the highly reactive polyol can have a primary hydroxyl number, defined as the hydroxyl number multiplied by the percentage of primary hydroxyl groups based on the total number of hydroxyl groups, of greater than 250.

Exemplary highly reactive polyols include plant-based polyols such as Pel-Soy 744 and Pel-Soy P-750, soybean oil based polyols commercially available from Pelron Corporation; Agrol Diamond, a soybean oil based polyol commercially available from BioBased Technologies; Ecopol 122, Ecopol 131 and Ecopol 132, soybean oil polyols formed using polyethylene terephthalate and commercially available from Ecopur Industries; Honey Bee HB-530, a soybean oil-based polyol commerically available from MCPU Polymer Engineering; Stepanpol PD-110 LV and PS 2352, polyols based on soybean oil, diethylene glycol and phthalic anhydride and commercially available from Stepan Company; Renewpol, a castor oil-based polyol commercially available from Styrotech Industries (Brooklyn Park, Minn.); JeffAdd B 650, a 65% bio-based content (using ASTM D6866-06) additive based on soybean oil commercially available from Huntsman Polyurethanes (Auburn Hills, Mich.); and derivatives thereof. In some embodiments, the highly reactive polyols can be formed by the reaction of a soybean oil and a polyester to produce a plant-based polyester polyol. An example of such a soybean oil-based polyester polyol is Ecopol 131, which is a highly reactive aromatic polyester polyol comprising 80% primary hydroxyl groups. Polyester polyols can be prepared using recyclable polyester to further increase the recyclable content of a composite material and Ecopol 131 is an example of such a polyester polyol. In some embodiments, the soybean oil and polyester based polyol can be prepared using recycled polyester. In some embodiments, the high hydroxyl number polyol can include renewable and recyclable content. In some embodiments, the composite materials can include 60-85% of highly reactive polyol such as a highly reactive soybean oil-based polyol (e.g., Ecopol 131) and 15-40% lesquerella oil.

The polyols or combinations of polyols useful with the composite materials described herein can have an average functionality of about 1.5 to about 8.0. Useful polyols additionally have an average functionality of about 1.6 to about 6.0, about 1.8 to about 4.0, about 2.5 to about 3.5, or about 2.6 to about 3.1. The average hydroxyl number values for the polyols useful with the composite materials described herein include hydroxyl numbers from about 100 to about 600, about 150 to about 550, about 200 to about 500, about 250 to about 430, about 300 to about 415, and about 340 to about 400.

Isocyanates useful with the composite materials described herein include at least one monomeric or oligomeric poly- or di-isocyanates. The monomeric or oligomeric poly- or di-isocyanate include aromatic diisocyanates and polyisocyanates. The isocyanates can also be blocked isocyanates or pre-polymer isocyanates (e.g., castor oil pre-polymer isocyanates and soy polyol pre-polymer isocyanates). An example of a useful diisocyanate is methylene diphenyl diisocyanate (MDI). Useful MDIs include MDI monomers, MDI oligomers, and mixtures thereof.

Further examples of useful isocyanates include those having NCO (i.e., the reactive group of an isocyanate) contents ranging from about 25% to about 35% by weight. Examples of useful isocyanates are found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Suitable examples of aromatic polyisocyanates include 2,4- or 2,6-toluene diisocyanate, including mixtures thereof; p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates are formed by the treatment of the isocyanates described herein with a blocking agent (e.g., diethyl malonate, 3,5-dimethylpyrazole, methylethylketoxime, and caprolactam). Isocyanates are commercially available, for example, from Bayer Corporation (Pittsburgh, Pa.) under the trademarks MONDUR and DESMODUR. Other examples of suitable isocyanates include Mondur MR Light (Bayer Corporation; Pittsburgh, Pa.), PAPI 27 (Dow Chemical Company; Midland, Mich.), Lupranate M20 (BASF Corporation; Florham Park, N.J.), Lupranate M70L (BASF Corporation; Florham Park, N.J.), Rubinate M (Huntsman Polyurethanes; Geismar, La.), Econate 31 (Ecopur Industries), and derivatives thereof.

The average functionality of isocyanates or combinations of isocyanates useful with the composites described herein can be between about 1.5 to about 5. Further, examples of useful isocyanates include isocyanates with an average functionality of about 2 to about 4.5, about 2.2 to about 4, about 2.4 to about 3.7, about 2.6 to about 3.4, and about 2.8 to about 3.2.

As indicated above, in the composite materials described herein, an isocyanate is reacted with a polyol, wherein the polyol consists essentially of one or more plant-based polyols (the one or more polyols including castor oil). In general, the ratio of isocyanate groups to the total isocyanate reactive groups, such as hydroxyl groups, water and amine groups, is in the range of about 0.5:1 to about 1.5:1, which when multiplied by 100 produces an isocyanate index between 50 and 150. Additionally, the isocyanate index can be from about 80 to about 120, from about 90 to about 120, from about 100 to about 115, or from about 105 to about 110. As used herein, an isocyanate may be selected to provide a reduced isocyanate index, which can be reduced without compromising the chemical or mechanical properties of the composite material.

As described above, the composite materials described herein include a polyurethane formed by the reaction of at least one isocyanate and at least one polyol in the presence of coal ash. The coal ash can be fly ash, bottom ash, or combinations thereof. In some examples, the coal ash used is fly ash. Fly ash is produced from the combustion of pulverized coal in electrical power generating plants. The fly ash useful with the composite materials described herein can be Class C fly ash, Class F fly ash, or a mixture thereof. Fly ash produced by coal-fueled power plants are suitable for incorporation in composites described herein.

Coal ash is present in the composites described herein in amounts from about 40% to about 90% by weight. Further, coal ash can be present in amounts from about 60% to about 85%. Examples of the amount of coal ash present in the composites described herein include about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, or about 90%.

One or more additional fillers can be used in the composite materials described herein. Examples of fillers useful with the composite materials include other types of ash such as those produced by firing fuels including industrial gases, petroleum coke, petroleum products, municipal solid waste, paper sludge, wood, sawdust, refuse derived fuels, switchgrass or other biomass material. The one of more additional fillers can also include ground/recycled glass (e.g., window or bottle glass); milled glass; glass spheres; glass flakes; glass fibers; activated carbon; calcium carbonate; aluminum trihydrate (ATH); silica; sand; ground sand; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; inorganic fibers; soy meal; pulverized foam; and mixtures thereof.

In some embodiments, inorganic fibers or organic fibers can be included in the polymer composite, e.g., to provide increased strength, stiffness or toughness. Fibers suitable for use with the composite materials described herein can be provided in the form of individual fibers, fabrics, rovings, or tows. These can be added prior to polymerization and can be chopped before or during the mixing process to provide desired fiber lengths. Alternately, the fibers can be added after polymerization, for example, after the composite material exits the mixing apparatus. The fibers can be up to about 2 in. in length. The fibers can be provided in a random orientation or can be axially oriented. The fibers can be coated with a sizing to modify performance to make the fibers reactive. Exemplary fibers include glass, polyvinyl alcohol (PVA), carbon, basalt, wollastonite, and natural (e.g., bamboo or coconut) fibers.

The inclusion of fillers in the composite materials as described herein can modify and/or improve the chemical and mechanical properties of the composite materials. For example, the optimization of various properties of the composite materials allows their use in building materials and other structural applications. High filler loading levels can be used in composite materials without a substantial reduction of (and potentially an improvement in) the intrinsic structural, physical, and mechanical properties of a composite.

The use of filled composites as building materials has advantages over composite materials made using lower filler levels or no filler. For example, the use of higher filler loading levels in building materials may allow the building materials to be produced at a substantially decreased cost. The use of large filler loadings also provides environmental advantages. For example, the incorporation of recyclable or renewable material, e.g., fly ash, as filler, provides a composite material with a higher percentage of environmentally friendly materials, i.e., a higher total environmental content. The use of the environmentally friendly materials in these composites decreases the need of landfills and other waste facilities to store such material. Another environmental benefit of using recyclable or renewable materials as filler in these composites includes reducing the production of virgin fillers that may involve energy-intensive methods for their creation and may produce waste or by-product materials.

One or more catalysts are added to facilitate curing and can be used to control the curing time of the polymer matrix. Examples of useful catalysts include amine-containing catalysts (such as DABCO and tetramethylbutanediamine) and tin-, mercury-, and bismuth-containing catalysts. In some embodiments, 0.01 wt % to 2 wt % catalyst or catalyst system (e.g., 0.025 wt % to 1 wt %, 0.05 wt % to 0.5 wt %, or 0.1 wt % to about 0.25 wt %) can be used.

Additional components useful with the composite materials described herein include foaming agents, blowing agents, surfactants, chain-extenders, crosslinkers, coupling agents, UV stabilizers, fire retardants, antimicrobials, anti-oxidants, and pigments. Though the use of such components is well known to those of skill in the art, some of these additional additives are further described herein.

Foaming agents and blowing agents may be added to the composite materials described herein to produce a foamed version of the composite materials. Examples of blowing agents include organic blowing agents, such as halogenated hydrocarbons, acetone, hexanes, and other materials that have a boiling point below the reaction temperature. Chemical foaming agents include azodicarbonamides (e.g., Celogen manufactured by Lion Copolymer Geismar); and other materials that react at the reaction temperature to form gases such as carbon dioxide. Water is an exemplary foaming agent that reacts with isocyanate to yield carbon dioxide. The presence of water as an added component or in the filler also can result in the formation of polyurea bonds through the reaction of the water and isocyanate.

The addition of excess foaming or blowing agents above what is needed to complete the foaming reaction can add strength and stiffness to the composite material, improve the water resistance of the composite material, and increase the thickness and durability of the outer skin of the composite material. Such excessive blowing agent may produce a vigorously foaming reaction product. To contain the reaction product, a forming device that contains the pressure or restrains the materials from expanding beyond the design limits may be used, such as a stationary or continuous mold.

Surfactants can be used as wetting agents and to assist in mixing and dispersing the inorganic particulate material in a composite. Surfactants can also stabilize and control the size of bubbles formed during the foaming event and the resultant cell structure. Surfactants can be used, for example, in amounts below about 0.5 wt % based on the total weight of the mixture. Examples of surfactants useful with the polyurethanes described herein include anionic, non-ionic and cationic surfactants. For example, silicone surfactants such as DC-197 and DC-193 (Air Products; Allentown, Pa.) can be used.

Low molecular weight reactants such as chain-extenders and/or crosslinkers can be included in the composite materials described herein. These reactants help the polyurethane system to distribute and contain the inorganic filler and/or fibers within the composite material. Chain-extenders are difunctional molecules, such as diols or diamines, that can polymerize to lengthen the urethane polymer chains. Examples of chain-extenders include ethylene glycol; 1,4-butanediol; ethylene diamine; 4,4′-methylenebis(2-chloroaniline) (MBOCA); diethyltoluene diamine (DETDA); and aromatic diamines such as Unilink 4200 (commercially available from UOP). Crosslinkers are tri- or greater functional molecules that can integrate into a polymer chain through two functionalities and provide one or more further functionalities (i.e., linkage sites) to crosslink to additional polymer chains. Examples of crosslinkers include glycerin, trimethylolpropane, sorbitol, diethanolamine, and triethanolamine. In some composites, a crosslinker or chain-extender may be used to replace at least a portion of the at least one polyol in the composite material. For example, the polyurethane can be formed by the reaction of an isocyanate, a polyol, and a crosslinker.

Coupling agents and other surface treatments such as viscosity reducers, flow control agents, or dispersing agents can be added directly to the filler or fiber, or incorporated prior to, during, and/or after the mixing and reaction of the composite material. Coupling agents can allow higher filler loadings of an inorganic filler such as fly ash and may be used in small quantities. For example, the composite material may comprise about 0.01 wt % to about 0.5 wt % of a coupling agent. Examples of coupling agents useful with the composite materials described herein include Ken-React LICA 38 and KEN-React KR 55 (Kenrich Petrochemicals; Bayonne, N.J.). Examples of dispersing agents useful with the composite materials described herein include JEFFSPERSE X3202, JEFFSPERSE X3202RF, and JEFFSPERSE X3204 (Huntsman Polyurethanes; Geismar, La.).

Ultraviolet light stabilizers, such as UV absorbers, can be added to the composite materials described herein. Examples of UV light stabilizers include hindered amine type stabilizers and opaque pigments like carbon black powder. Fire retardants can be included to increase the flame or fire resistance of the composite material. Antimicrobials can be used to limit the growth of mildew and other organisms on the surface of the composite. Antioxidants, such as phenolic antioxidants, can also be added. Antioxidants provide increased UV protection, as well as thermal oxidation protection.

Pigments or dyes can optionally be added to the composite materials described herein. An example of a pigment is iron oxide, which can be added in amounts ranging from about 2 wt % to about 7 wt %, based on the total weight of the composite material.

Examples of compositions illustrating aspects of the composites as described herein are shown in Tables 1-3. Exemplary ingredients for a first fly ash filled composite material (Composite 1) are shown in Table 1. In Composite 1, fly ash filler and glycerin both have recyclable content, and lesquerella oil has renewable content. The surfactants, catalysts, water, and glass fibers are not generally considered to have renewable or recyclable content. The use of lesquerella oil as the polyol provides a polyurethane component of the composite (based only on the polyols and isocyanates) with a total environmental content of 41.66 wt %, and the total environmental content for Composite 1 is 79.84%.

TABLE 1
Composite 1

| | | | Renewable | |
|---|---|---|---|---|
| | | Renewable | Content | Recyclable |
| Ingredient | Units | Content, % | Units | Units |
| Fly ash | 711.38 | 0 | — | 711.38 |
| Lesquerella Oil | 85.00 | 100 | 85.00 | — |
| Glycerin | 15.00 | 0 | — | 15.00 |
| Surfactant | 1.00 | 0 | — | — |
| Catalyst | 1.00 | 0 | — | — |
| Water | 1.80 | 0 | — | — |
| Fiber | 60.97 | 0 | — | — |
| Isocyanate | 140.04 | 0 | — | — |
| Delayed catalyst | 0.06 | 0 | — | — |
| Total Units | 1016.25 | | | |
| Total Renewable | — | — | 85.00 | — |
| Units | | | | |
| Total Recyclable | — | — | — | 726.38 |
| Units | | | | |
| % Fly Ash | 70.00 | | | |
| % Renewable | 8.36 | | | |
| Content | | | | |
| % Recyclable | 71.48 | | | |
| Content | | | | |
| Total Environmental | 79.84 | | | |
| Content | | | | |

Exemplary ingredients for a second fly ash filled composite material (Composite 2) are shown in Table 2. Composite 2 includes Ecopol 131, which is understood from the product literature to include 40% soybean oil (renewable content) and 40% recycled polyester (recyclable content). In Composite 2, the fly ash filler contains recyclable content, and lesquerella oil has renewable content. In this example, surfactants, catalysts, water, and glass fibers are not considered to contain renewable or recyclable content. The use of lesquerella oil as the polyol provides a polyurethane component of the composite with a total environmental content of 38.97 wt %, and the total environmental content for Composite 2 is 79.19%.

TABLE 2
Composite 2

| | | | Renewable | |
|---|---|---|---|---|
| | | Renewable | Content | Recyclable |
| Ingredient | Units | Content, % | Units | Units |
| Fly ash | 639.54 | 0 | — | 639.54 |
| Lesquerella Oil | 20.00 | 100 | 20.00 | — |
| Ecopol 131 | 80.00 | 40 | 32.00 | 32.00 |
| Surfactant | 1.00 | 0 | — | — |
| Catalyst | 1.00 | 0 | — | — |
| Water | 1.70 | 0 | — | — |
| Fiber | 54.82 | 0 | — | — |
| Isocyanate | 115.55 | 0 | — | — |
| Delayed catalyst | 0.02 | 0 | — | — |
| Total Units | 913.63 | | | |
| Total Renewable | — | — | 52.00 | — |
| Content Units | | | | |
| Total Recyclable | — | — | — | 671.54 |
| Units | | | | |
| % Fly Ash | 70.00 | | | |
| % Renewable- | 5.69 | | | |
| Content | | | | |
| % Recyclable | 73.50 | | | |
| Content | | | | |
| Total Environmental | 79.19 | | | |
| Content | | | | |

Exemplary ingredients for a third fly ash filled composite material (Composite 3) are shown in Table 3. In Composite 3, fly ash filler and glycerin contain recyclable content, and lesquerella oil contains renewable content. The surfactants, catalysts, water, and glass fibers are not considered to contain renewable or recyclable content. The use of lesquerella oil as the polyol provides a polyurethane component of the composite with a total environmental content of 37.45 wt %, and the total environmental content for Composite 3 is 78.83%.

TABLE 3
Composite 3

| | | Renewable | Renewable | Recyclable |
|---|---|---|---|---|
| Ingredient | Units | Content, % | Units | Units |
| Fly ash | 665.03 | 0 | — | 665.03 |
| Lesquerella Oil | 18.00 | 100 | 18.00 | — |
| Ecopol 131 | 80.00 | 40 | 32.00 | 32.00 |
| Glycerin | 2.00 | 0 | — | 2.00 |
| Surfactant | 1.00 | 0 | — | — |
| Catalyst | 1.00 | 0 | — | — |
| Water | 1.70 | 0 | — | — |
| Fiber | 57.00 | 0 | — | — |
| Isocyanate | 124.29 | 0 | — | — |
| Delayed catalyst | 0.02 | 0 | — | — |
| Total Units | 950.04 | | | |
| Total Renewable | — | — | 50.00 | — |
| Units | | | | |
| Total Recyclable | — | — | — | 699.03 |
| Units | | | | |
| % Fly Ash | 70.00 | | | |
| % Renewable | 5.26 | | | |
| Content | | | | |
| % Recyclable | 73.57 | | | |
| Content | | | | |
| Total Environmental | 78.83 | | | |
| Content | | | | |

Composites 1-3 used as examples above are all based upon a filler loading of about 70 wt % fly ash. However, filler loading can be increased to about 85 wt % fly ash or greater, which would increase the total environmental content (other component amounts being held constant). While the percentages of lesquerella oil in exemplary Composites 1-3 were at 85%, 20%, and 18%, the percentages of lesquerella oil as a portion of the polyol can be, for example, 10-50%, 15-45%, 15-40%, 20-40%, 25-40%, or 30-40%. For further example, the percentages of lesquerella oil as a portion of the polyol can be 10%, 15%, 20%, 25%, 30%, 35%, 40%, 45%, or 50%.

A method of preparing a composite material is also described herein. The method includes mixing (1) at least one isocyanate selected from the group consisting of diisocyanates, polyisocyanates, and mixtures thereof; (2) at least one polyol, wherein the polyol includes lesquerella oil; (3) coal ash (e.g., fly ash) present in amounts from about 40% to about 90% by weight of the composite material; and (4) a catalyst. The at least one isocyanate and the at least one polyol are allowed to react in the presence of the coal ash and catalyst to form the composite material.

The composite material can be produced using a batch, semi-batch, or continuous process. At least a portion of the mixing step, reacting step, or both, can be conducted in a mixing apparatus such as a high speed mixer or an extruder. The method can further include the step of extruding the resulting composite material through a die or nozzle. In some embodiments, a mixing step of the method used to prepare the composite materials described herein includes: (1) mixing the polyol and fly ash; (2) mixing the isocyanate with the polyol and the fly ash; and (3) mixing the catalyst with the isocyanate, the polyol, and the fly ash. In some embodiments, a mixing step of the method used to prepare the composite materials described herein includes mixing the liquid ingredients (i.e., the polyol, isocyanate, catalyst, surfactants, and water) and then combining the mixed liquid ingredients with the fly ash and optional fiber. As the composite material exits the die or nozzle, the composite material may be placed in a mold for post-extrusion curing and shaping. For example, the composite material can be allowed to cure in individual molds or it can be allowed to cure in a continuous forming system such as a belt molding system.

An ultrasonic device can be used for enhanced mixing and/or wetting of the various components of the composite materials described herein. Such enhanced mixing and/or wetting can allow a high concentration of filler (e.g., fly ash) to be mixed with the polyurethane matrix, including about 40 wt %, about 50 wt %, about 60 wt %, about 70 wt %, about 80 wt %, and about 90 wt % of the inorganic filler. The ultrasonic device produces an ultrasound of a certain frequency that can be varied during the mixing and/or extrusion process. The ultrasonic device useful in the preparation of composite materials described herein can be attached to or adjacent to an extruder and/or mixer. For example, the ultrasonic device can be attached to a die or nozzle or to the port of an extruder or mixer. An ultrasonic device may provide de-aeration of undesired gas bubbles and better mixing for the other components, such as blowing agents, surfactants, and catalysts.

The composite materials described herein can be foamed. The at least one polyol and the at least one isocyanate can be allowed to produce a foamed composite material after mixing the components according to the methods described herein. The composite materials described herein can be formed while they are actively foaming or after they have foamed. For example, the material can be placed under the pressure of a mold cavity prior to or during the foaming of the composite material. When a foaming composite material is molded by a belt molding system into a product shape, the pressure that the foamed part exerts on the belts impacts the resulting mechanical properties. For example, as the pressure of the foaming increases and if the belt system can hold this pressure without the belts separating, then the product may have higher flexural strength than if the belts allowed leaking or pressure drop.

The composite materials described herein can be formed into shaped articles and used in various applications including building materials. Examples of such building materials include siding material, roof coatings, roof tiles, roofing material, carpet backing, flexible or rigid foams such as automotive foams (e.g., for dashboard, seats or roofing), component coating, and other shaped articles. Examples of shaped articles made using composite materials described herein include roofing material such as roof tile shingles; siding material; trim boards; carpet backing; synthetic lumber; building panels; scaffolding; cast molded products; decking materials; fencing materials; marine lumber; doors; door parts; moldings; sills; stone; masonry; brick products; posts; signs; guard rails; retaining walls; park benches; tables; slats; and railroad ties. The composite materials described herein further can be used as reinforcement of composite structural members including building materials such as doors; windows; furniture; and cabinets and for well and concrete repair. The composite materials described herein also can be used to fill gaps, particularly to increase the strength of solid surface articles and/or structural components. The composite materials can be flexible, semi-rigid or rigid foams. In some embodiments, the flexible foam is reversibly deformable (i.e. resilient) and can include open cells. A 8″×1″×1″ piece of a flexible foam can generally wrap around a 1″ diameter mandrel at room temperature without rupture or fracture. Flexible foams also generally have a density of less than 5 lb/ft³ (e.g. 1 to 5 lb/ft³). In some embodiments, the rigid foam is irreversibly deformable and can be highly crosslinked and/or can include closed cells. Rigid foams generally have a density of 5 lb/ft³ or greater (e.g. 5 to 60 lb/ft³, 20 to 55 lb/ft³, or 30 to 50 lb/ft³).

The composites and methods of the appended claims are not limited in scope by the specific composites and methods described herein, which are intended as illustrations of a few aspects of the claims and any composites and methods that are functionally equivalent are intended to fall within the scope of the claims. Various modifications of the composites and methods in addition to those shown and described herein are intended to fall within the scope of the appended claims. Further, while only certain representative composite materials and method steps disclosed herein are specifically described, other combinations of the composite materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

That which is claimed:

1. A composite material comprising:
a polyurethane formed by the reaction of at least one isocyanate selected from the group consisting of diisocyanates, polyisocyanates and mixtures thereof, and at least one polyol wherein the at least one polyol includes lesquerella oil, and
from about 40% to about 90% by weight coal ash.

2. The composite material of claim 1, wherein the coal ash comprises fly ash.

3. The composite material of claim 1, wherein the at least one polyol consists essentially of plant-based polyols.

4. The composite material of claim 1, wherein the at least one polyol includes a soybean oil-based polyol.

5. The composite material of claim 4, wherein the soybean oil-based polyol is formed by the reaction of a soybean oil and a polyester.

6. The composite material of claim 5, wherein the soybean oil and polyester based polyol is prepared using recyclable polyester.

7. The composite material of claim 1, wherein the at least one polyol further includes a polyol having 75% or more primary hydroxyl groups.

8. The composite material of claim 1, wherein the polyurethane component has a total environmental content of greater than 35%.

9. The composite material of claim 1, wherein the composite material has a total environmental content of greater than 75%.

10. The composite material of claim 1, wherein the composite material is foamed.

11. The composite material of claim 1, wherein the coal ash is from about 60% to about 85% by weight.

12. The composite material of claim 1, further comprising glass fibers.

13. The composite material of claim 1, wherein the polyurethane is formed by the reaction of the isocyanate, the polyol, and a crosslinker.

14. The composite material of claim 13, wherein the crosslinker includes glycerin.

15. The composite material of claim 1, wherein the at least one polyol comprises 60% to 85% of soybean oil-based polyol and 15% to 40% lesquerella oil.

16. A building material comprising the composite material of claim 1.

17. The building material of claim 16, wherein the building material is rigid.

18. A method of preparing a composite material comprising:
mixing (1) at least one isocyanate selected from the group consisting of diisocyanates, polyisocyanates and mixtures thereof, (2) at least one polyol wherein the at least one polyol includes lesquerella oil, (3) coal ash, and (4) a catalyst; and
allowing the at least one isocyanate and the at least one polyol to react in the presence of the coal ash and catalyst to form the composite material,
wherein the amount of coal ash added in the mixing step comprises from about 40% to about 90% by weight of the composite material.

19. The method of claim 18, wherein the coal ash comprises fly ash.

20. The method of claim 18, wherein the at least one polyol consists essentially of plant-based polyols.

21. The method of claim 18, wherein the at least one polyol includes a soybean oil-based polyol.

22. The method of claim 21, wherein the soybean oil-based polyol is formed by the reaction of a soybean oil and a polyester.

23. The method of claim 22, wherein the soybean oil and polyester based polyol is prepared using recyclable polyester.

24. The method of claim 18, wherein the at least one polyol further includes a polyol having 75% or more primary hydroxyl groups.

25. The method of claim 18, wherein the total environmental content of a combination of the at least one isocyanate and the at least one polyol components is greater than 35%.

26. The method of claim 18, wherein the composite material has a total environmental content of greater than 75%.

27. The method of claim 18, wherein the mixing step further comprises mixing glass fibers.

28. The method of claim 18, wherein the mixing step further comprises mixing a crosslinker.

29. The method of claim 28, wherein the crosslinker includes glycerin.

30. The method of claim 18, wherein the at least one polyol comprises 60% to 85% soybean oil-based polyol and 15% to 40% lesquerella oil.
